(19) United States
(12) Patent Application Publication
(10) Pub. No.: US 2006/0206942 A1
(43) Pub. Date: Sep. 14, 2006

(54) Field interview kit

(75) Inventor: John M. Sweet, Purcellville, VA (US)

Correspondence Address: The Law Offices of James J. Ralabate, 5792 Main Street, Williamsville, NY, 14221, US

(73) Assignee: Xybernaut Corporation

(21) Appl. No.: 11/077,402

(22) Filed: Mar. 10, 2005

(51) Int. Cl. H04N 7/16

(52) U.S. Cl. 726/26

(57) ABSTRACT

The identification, registration, and recordation of individuals are facilitated by allowing the authorities (federal, state, or local law enforcement) and first responders (fire, rescue, hazmat personnel) to collect data at the point of response utilizing a portable computer and suitable software. The portable computer may be equipped with peripherals such as a camera, a biometric collection unit (e.g., fingerprint scanner), a smart card reader, and a GPS receiver to facility gathering and entry of data in the computer. The identity of individuals being questioned by the authorities can be confirmed at the point of questioning with an electronic repository to which the portable computer may be connected.

### FIELD

This invention generally relates to mobile computers. More specifically, this invention relates to the collection of information utilizing mobile computers.

### BACKGROUND

Over the past several years, security concerns have become unavoidable. Those in the position of being first responders and security personnel whether it be civilian (e.g. fire, police, emergency rescue), governmental (e.g. border patrol, customs), or military, are at the greatest risk and need updated and correct information instantly. Traditionally, those first responders and security personnel who are responsible for international entry points such as border and harbor must inspect both cargo and personnel and need correct information instantly before allowing cargo or personnel to enter the country.

Conventionally, first responders and security personnel use a paper based system for collecting information about suspicious individuals, typically recording information such as name, social security number, height, weight, etc. This information must be collected and, then, manually entered into a computer database. Also, the collection of biometric information of the individual such as fingerprint and photographs occurs later at a security station. Under this procedure, the information collected by the first responder and security personnel will not become available in real-time. Further, the first responder and security personnel cannot compare the collected information with records regarding security threats. Because of this, the first responder and security personnel may be unable to stop security threats at international entry points.

### SUMMARY

One aspect of the present invention is a method for identifying a entity, comprising, under control of a first computer: inputting data identifying the entity into the first computer, and transmitting matched information, wherein the matched information comprises a portion of the data matched with a corresponding information field identifier; under control of a second computer: receiving the matched information from the first computer; analyzing the matched information; and generating a profile of the entity based on the analysis; wherein the profile is available to the first computer to identify the entity.

Another aspect of the present invention is a system for identifying an entity, comprising, a first computer comprising: a means for inputting data identifying the entity into the first computer, a means for storing at least a portion of the data identifying the entity, and a means for transmitting matched information, wherein the matched information comprises the data and a corresponding information field identifier; a second computer comprising: a means for analyzing the matched information and generating a profile based on the analysis, a means for storing the matched information and the profile, and a means for communicating with the first computer to receive the matched information from the first computer and to transmit the profile to the first computer.

Still another aspect of the present invention is a method for interviewing an entity comprising: identifying information about the entity; inputting the information about the entity into a portable device; arranging the information inputted into the portable device in a organized manner to form organized information; transferring the organized information to a computer; analyzing the organized information at the computer to generate a profile of the entity; transferring the profile from the computer to the portable device.

A further aspect of the invention is a method of identification of at least one entity, comprising: collecting data at a point of inspection related to the at least one entity; entering the data into a first computer; transmitting the data to a second computer, wherein the second computer includes storage device, the storage device containing a database of information relating to a plurality of entities; comparing the data with the database of information stored in the storage device; generating an individual profile based at least on part of the comparison of the data; transmitting the profile from the second computer to the first computer.

A still further aspect of the invention is a system for identifying an entity, comprising, a first computer comprising: a first communication bus, a first processor coupled to the first communication bus, an input device coupled to the first communication bus for inputting information about the entity into the first computer, a first storage device coupled to the first communication bus for storing at least a portion of the information and a program to categorize the information, and a first communication device coupled to the first communication bus and in communication with a network; a second computer comprising: a second communication bus, a second processor coupled to the second communication bus, a second storage device coupled to the second communication bus for storing a program to perform an analysis on the information input into the first computer and generate a profile, and a second communication device coupled to the second communication bus and in communications with the network, wherein the profile is available to the first computer via the network.

The foregoing and additional aspects of the invention together with the structure characteristics thereof, which is only briefly summarized in the foregoing passages, becomes more apparent to those skilled in the art upon reading the detailed description and exemplary embodiments, which follow in this specification, taken together with the illustration thereof presented in the representative accompanying drawings.

### BRIEF DESCRIPTION OF THE DRAWINGS

FIG. 1A illustrates a top view a device consistent with aspects related to the present invention

FIG. 1B illustrates a side view of a device consistent with aspects related to the present invention

FIG. 2 illustrates a top view of a device consistent with aspects related to the present invention

FIG. 3 illustrates an exemplary Field Interrogation Card consistent with aspects related to the present invention

FIG. 4A illustrates another exemplary Field Interrogation Card consistent with aspects related to the present invention.

FIG. 4B illustrates another exemplary Field Interrogation Card consistent with aspects related to the present invention.

FIG. 5 illustrates a system for gathering information on a person of interest consistent with aspects related to the present invention

FIG. 6A illustrates a method for gathering information on a person of interest consistent with aspects related to the present invention

FIG. 6B illustrates a method for gathering information on a person of interest consistent with aspects related to the present invention.

### DETAILED DESCRIPTION

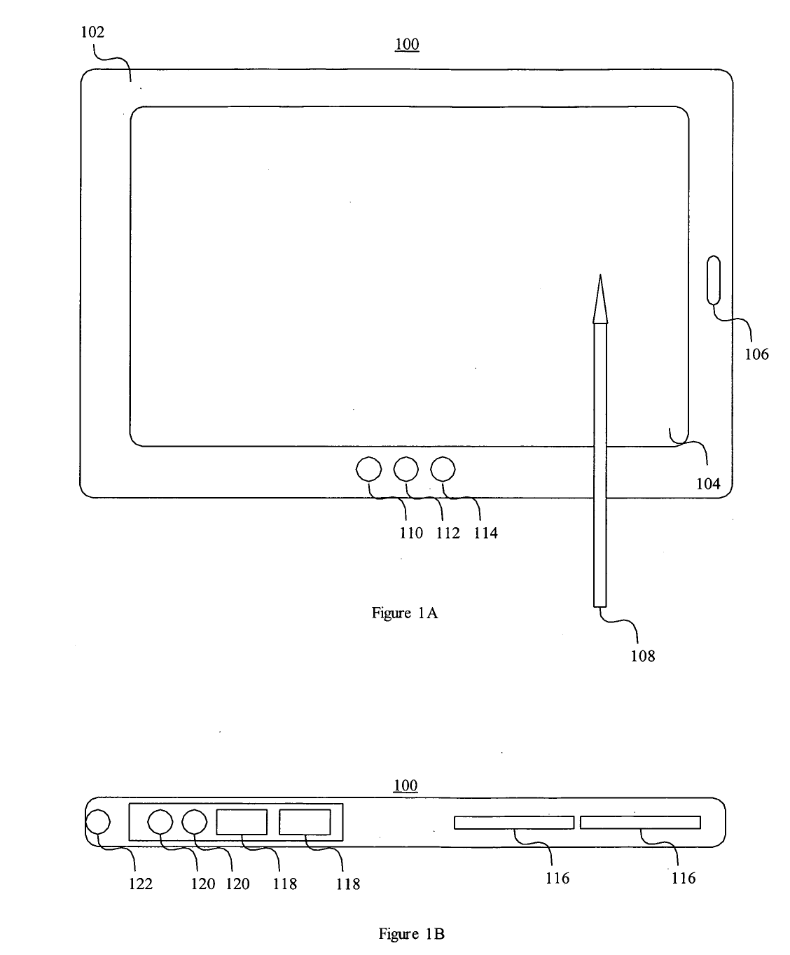

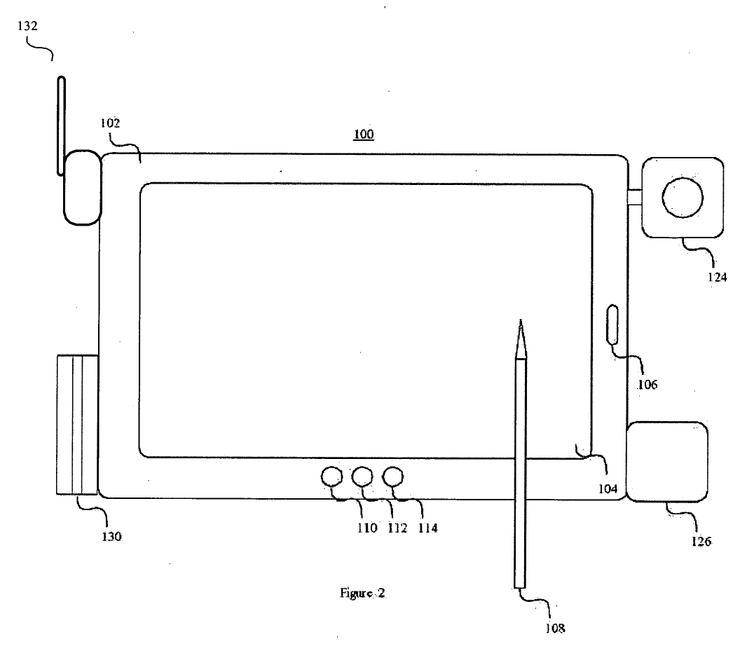

FIG. 1A illustrates a top view of device 100 for collecting and analyzing information consistent with aspects related to the present invention. Device 100 may be a thin client computer, a dual use computer, a user-supported computer which may be activated or operated, in part, with a user's voice, or a stand-alone computer such as pen tablet computer or laptop computer. Device 100 may also be computers similar to those described in U.S. Pat. No. 5,305,244, U.S. Pat. No. 5,844,824 (“824 patent”), U.S. Pat. No. 6,421,232, or a combination of these computers. These three U.S. patents mentioned above are all owned by the assignee of the present application, Xybernaut Corporation, and are hereby incorporated by reference in their entirety into the present disclosure. Device 100 is composed of an enclosure 102 and display screen 104. The display screen 104 may be responsive to input and activation from stylus 108. For example, display screen 104 may be a touch screen enabled liquid crystal display. Other mechanisms of input and activation of the device 100 through the display screen 104 include touch activation (not shown) or through control buttons 110, 112, and 114 located on the enclosure 102.

Device 100 contains the standard components of a computer. Device 100 may include a processor, memory, buses, video hardware, sound hardware, and input output ports. The processor may be, for example, a central processing unit (CPU), a micro-controller unit (MCU), digital signal processor (DSP), or the like. The memory may be a read only memory (ROM), a random access memory (RAM), or a memory with other access options. The memory may be physically implemented by computer-readable media, such as, for example; magnetic media, such as a hard disk, a floppy disk, or other magnetic disk, a tape, a cassette tape; optical media, such as optical disk (CD-ROM, DVD); semiconductor media, such as DRAM, SRAM, EPROM, EEPROM, or memory stick. Further, portions of the memory may be removable or non-removable.

The memory may store and support modules such as, for example, a basic input output system (BIOS), an operating system (OS), a program library, a compiler, an interpreter, a text-processing toot and other programs such as database, word-processor, web-browser, and voice-recognition

FIG. 1B illustrates an exemplary side view of device 100. As illustrated in FIG. 1B, device 100 includes expansion card slots 116, peripheral ports 118 and 120, and a stylus holder 122. Expansion card slot 116 allows an expansion card to be inserted into and function with device 100. Examples of expansion cards that can be used with device 100 include PC cards (Type I, II, or III), small PC Cards, Miniature Cards, SmartMedia Cards, Multimedia Cards, and CompactFlash. The functions that these types of cards perform range from memory (nonvolatile and volatile), storage, and I/O. The device is also shown with peripheral ports 118 and 120 which can include but are not limited to serial ports such as USB and IEEE 1394 (“Firewire”) and video ports such as digital visual interface (“DVI”), VGA input, and VGA output. FIG. 1B illustrates device 100 having all peripheral ports on one side of the device 100; however, peripheral ports may be located on any surface of device 100. Device 100 is also shown with stylus holder 122 that allows the stylus 108 to be stored inside enclosure 102.

In an exemplary embodiment, device 100 may be a thin client computer or dual-use computer. In this exemplary embodiment, device 100 would have dimensions of approximately H×W×D: 7.9″ (200 mm)×9.4″ (240 mm)×0.7″ (18 mm) and a weight of approximately 1.8 lbs. (840 g), including battery. In this exemplary embodiment, device 100 would include a processor such as a TRANSMETA CRUSOE Processor, volatile memory such as SDRAM, non-volatile memory such as Flash Memory; input ports such as PC Card (CardBus Type II) CompactFlash Type II (CF-IO), USB 2.0, audio hardware such as integrated 16-bit Stereo Audio System, Stereo Speakers, Headset Jack. In this exemplary embodiment, display screen 104 would be an 8.4 inch touch screen enabled TFT-Transmissive liquid crystal display. In this exemplary embodiment, programs stored in the volatile and nonvolatile memory include, but not limited to, MICROSOFT WINDOWS XP Embedded, Microsoft Internet Explorer 6 WINDOWS MEDIA Player 8 Sun JAVA 2 Runtime Environment, Standard Ed. 1.4, RDP and ICA Clients for Microsoft Terminal and CITRIX METAFRAME Servers.

FIG. 2 illustrates another exemplary top view of device 100. Device 100 shown in the form of a portable tablet-style computer includes a camera 124 which may be selectively detachable from the enclosure 102 of the device 100. Camera 124 may be a video camera, a still image camera, or a mixture of video or still camera. Camera 124 may be connected to enclosure 102 by a movable joint such that the camera can tilt to increase the field of view of the camera. Camera 124 may be powered by power supply of the device 100, either AC or DC power, or by its own internal power supply. For example, camera 124 may be integrated with an expansion card to allow the camera to be connected to device directly at expansion slot 116. Additionally, camera 124 may be integrated into device 100 such that it is part of the housing of device 100. Alternatively, camera 124 may be a separate device which can be carried by the user.

Device 100 may also include a biometric collection unit 126. Biometric collection unit 126 may collect biometric information such as fingerprint, iris, voice, and handwriting information. For example, biometric collection unit 126 may be any fingerprint reader which can attach to device 100 or be transported by a user and connected to device 100. The fingerprint reader may be an optical scanner or a capacitive scanner. An optical scanner would contain a charged-coupled device (CCD) for capturing an image of the fingerprint. A capacitive scanner would include semiconductor circuitry and conductor plates for detecting fingerprint detail.

Biometric collection unit 126 may be connected to device 100 through a PC card or other suitable peripheral connectors. Biometric collection unit 126 may be physically attached to device 100 as show in FIG. 2. Additionally, biometric collection unit 126 may be integrated into device 100 such that it is part of the housing of device 100. Alternatively, biometric collection unit 126 may be a separate device which can be carried by the user. Biometric collection unit 126 may be powered by power supply of the device 100, either AC or DC power, or by its own internal power supply.

Device 100 may utilize camera 124 as the biometric collection unit 126. The camera 124 may collect biometric information such as photos and iris scans. The camera 124 is equipped to illuminate and capture iris image.

Device 100 may also include a magnetic or smart card reader 130. Magnetic or smart card reader 130 may be integrated into device 100 or connected to the device 100 through a peripheral connector. Magnetic or smart card reader 130 contains the standard components of a conventional reader which extracts data from a magnetic media or integrated circuit (IC) chip media. Magnetic or smart card reader 130 may be physically attached to device 100 as show in FIG. 2. Additionally, magnetic or smart card reader 130 may be integrated into device 100 such that it is part of the housing of device 100. Alternatively, magnetic or smart card reader 130 may be a separate device which can be carried by the user. Magnetic or smart card reader 130 may be powered by power supply of the device 100, either AC or DC power, or by its own internal power supply.

Device 100 may also include a GPS receiver 132. GPS receiver 132 may be integrated into device 100 or connected to the device 100 through a peripheral connector. GPS receiver 132 includes the standard components of a conventional GPS device. The standard components may include, for example, an antenna, clock, and processor. GPS receiver 132 may be physically attached to device 100 as show in FIG. 2. Additionally, GPS receiver 132 may be integrated into device 100 such that it is part of the housing of device 100. Alternatively, GPS receiver 132 may be a separate device which can be carried by the user. GPS receiver 132 may be powered by power supply of the device 100, either AC or DC power, or by its own internal power supply.

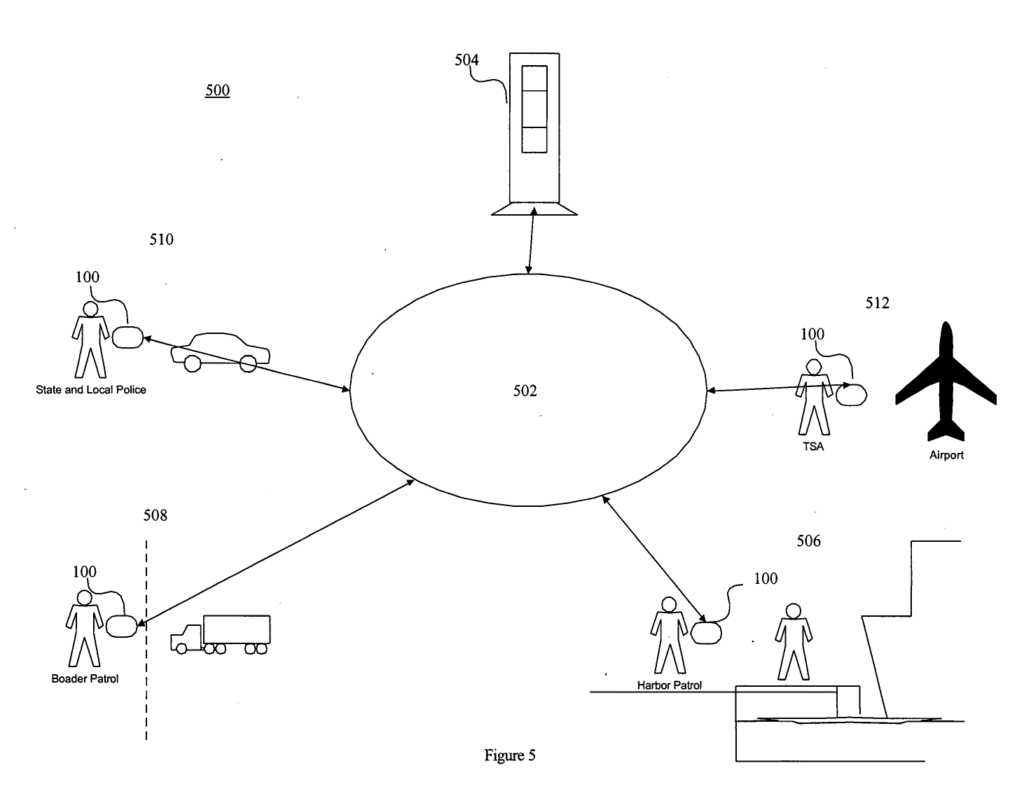

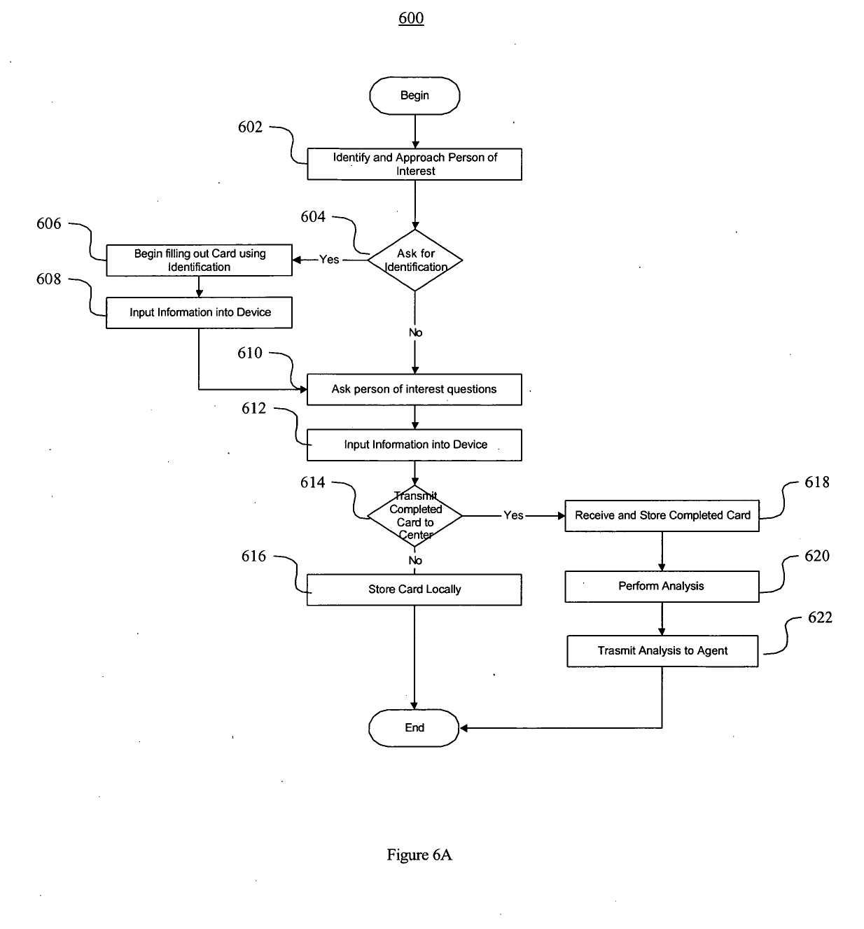

Device 100 may be utilized by law enforcement agents, border patrol agents, custom agents, transportation security agency agents, and harbor patrol agents (hereinafter generally referred to as “agents”). Device 100 allows these various agents to efficiently collect and categorize data on particular entities of interest (e.g., persons, vehicles, buildings, or places) such as interviewing persons of interest. The data collected by the agents utilizing device 100 may include biometric information such as behavioral or physiological characteristics to determine or verify identity. Examples of common biometric information that can be captured with device 100 using biometric collection unit include fingerprint, photos, iris, voice, and handwriting. Further, by linking device 100 with at least one computer 504 (described below in relation to FIG. 5), various agents can immediately upload data on these entities of interest and receive any known information about these entities from the computer 504.

Agents are able to categorize, arranged, and collect information about an entity of interest using various Field Interrogation Cards (“FIC” or “cards”) which are used in connection with device 100. Cards are data arrangement structures which allow agents to enter and categorize data about an entity of interest on device 100. These cards normally would comprise a series of fields in which the agent could enter the information about an entity of interest. Each field would have a specific designation for receiving particular information about an entity of interest. Each field of the card may have a unique field identifier. The field identifier would be matched with the information in that particular field. Therefore, when data is transmitted between device 100 and computer 504, the data and field identifier may be sent together to allow the data to be displayed in an organized manner.

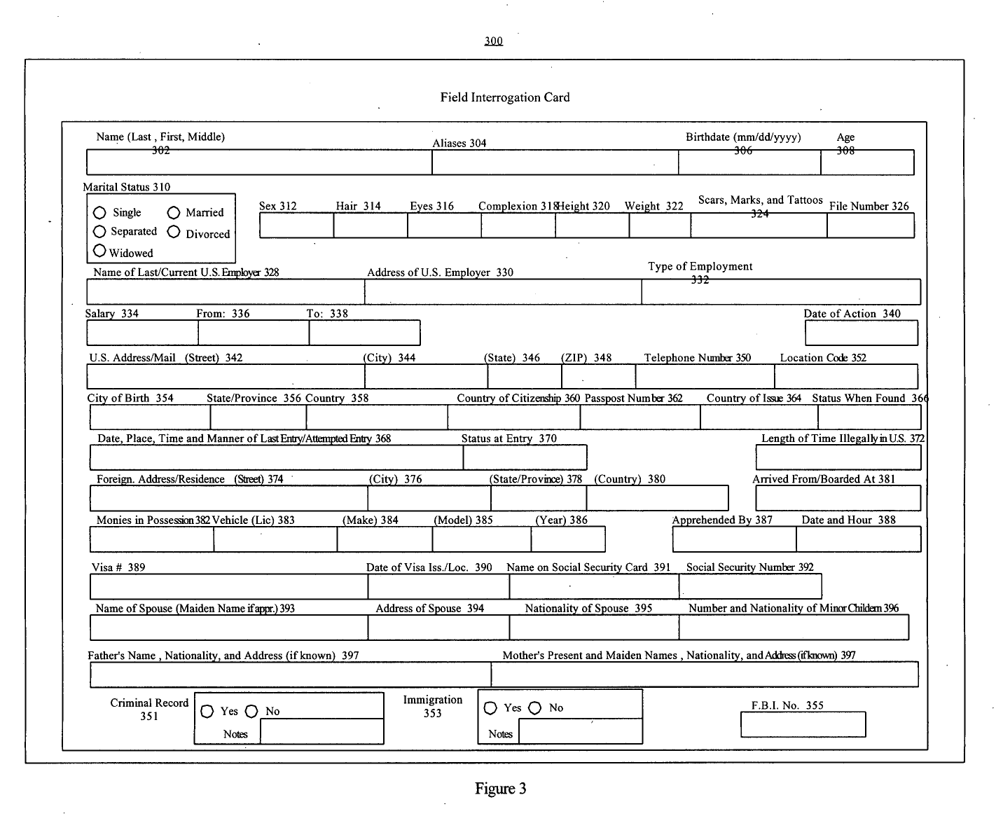

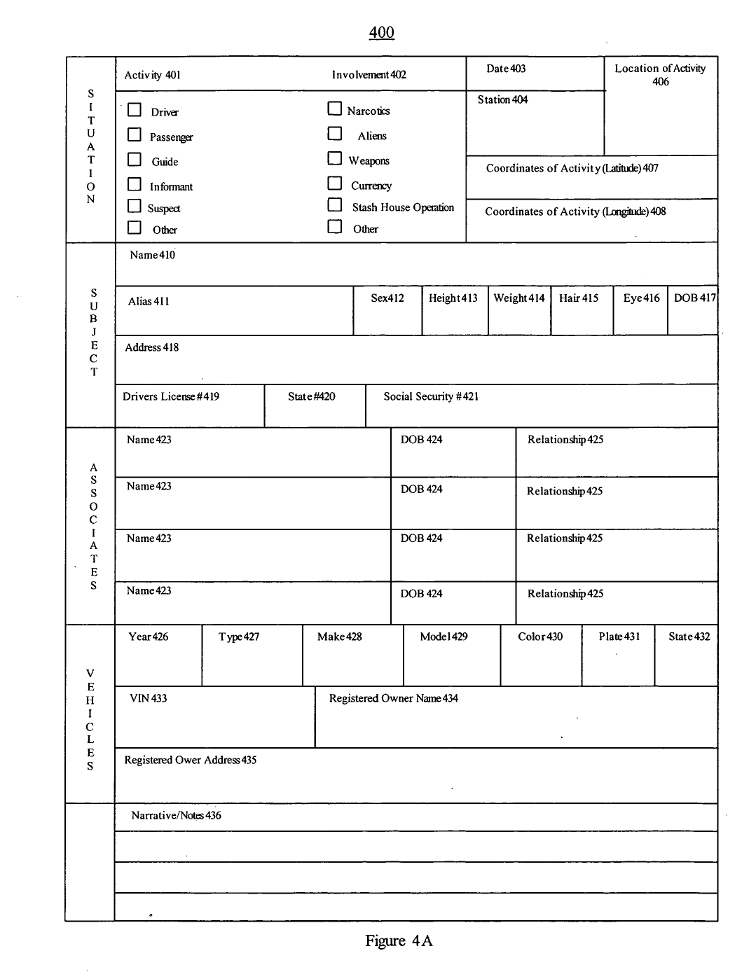

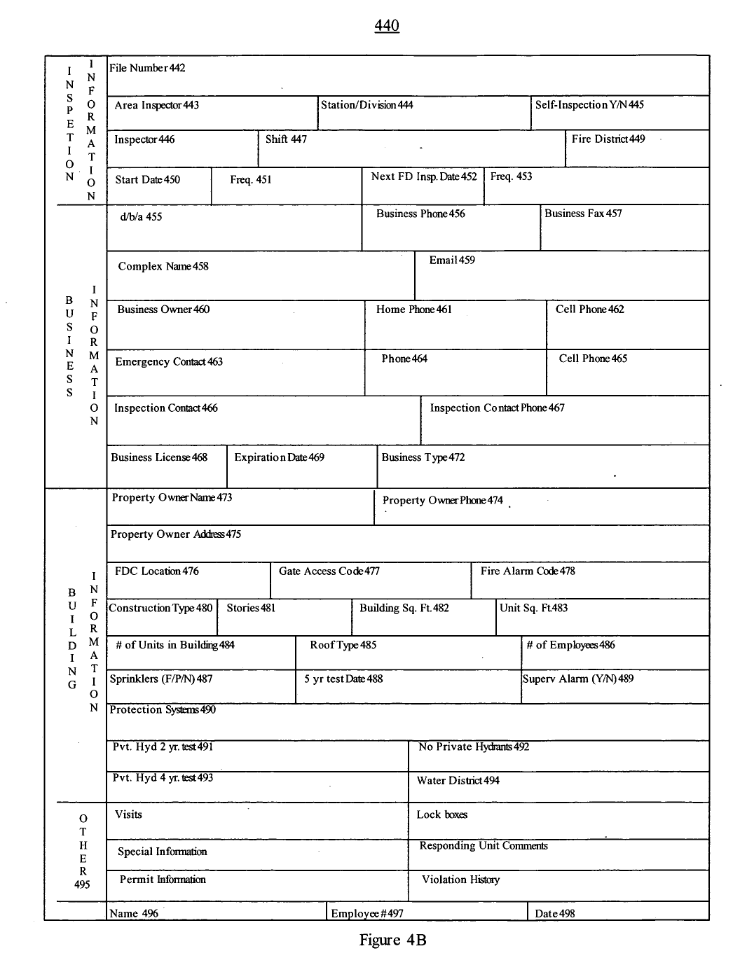

FIGS. 3 and 4 illustrated exemplary cards for collecting and categorizing information about an entity of interest. The exemplary cards illustrated in FIGS. 3 and 4 are not intended to be limiting of the types of cards used by device 100. Device 100 may utilize any type of card which is capable of collecting and categorizing information. Further, the exemplary cards illustrated in FIGS. 3 and 4 and other types are not intended to be static. Any of the cards may be modified and changed by an agent or other person in the event a different field is need to collect and categorize information about an entity of interest. Data can be inputted into FIC utilizing a variety of input mechanism including keyboard, pen input utilizing handwriting recognition software, voice input, or through reading a magnetic storage card with card reader 130. It is not necessary that all fields of the FIC be filled out at the time of questioning, but enough that a record of the entity being questioned is created.

FIG. 3 illustrates an exemplary template for a Field Interrogation Card (FIC) which will be accessible on device 100. Name of the person being questioned, preferably in the format last, first, and middle name, is inputted into Field 302. If the person has any known aliases, this information can be inputted into Field 304. The birth date, preferably in the format of month, day, and year, is entered into Field 306. The age of the person being questioned is inputted into Field 308.

The current martial status (single, separated, widowed, married, or divorced) of the person being questioned is inputted into Field 310. The sex (Field 312), hair color/condition (balding) (Field 314), eye color (Field 316), complexion (Field 318), height (Field 320), weight (Field 322) can all be inputted into their respective fields. Also, each of the Fields 312 to 322 may be enhanced through use of drop down menus. For example, when the agent touches or activates Field 312, choices such as male, female, and other appear. Further, for Field 316, choices such as blue, brown, hazel, grey, and green appear. This will facilitate entry of data into the FIC. Field 324 allows the agent to specify any identifiable scars, marks, and/or tattoos. Field 326 is File Number which, preferably, would update each time the FIC was opened such that each new case would have a unique File Number.

Fields 328 to 338 are for questions related to the employment of the person being questioned. Field 328 allows entry of the name of last/current U.S. employer of the person being questioned. Field 330 is for the address of the U.S. employer and Field 332 is for the type of employment of the person being questioned. Field 334 is for entry of the salary or range in salary and Fields 336 and 338 is for the dates of employment.

Field 340 allows the agent to enter the date at which the current questioning is taking place. Alternatively, this field may auto populate with the current date and time when the FIC is opened. The FIC may copy the current date and time from the system clock of the device 100.

Fields 342 to 352 are for questions related to the residence of the person being questioned. Field 342 is for the physical residence or P.O. Box. Field 344 is for the city or county and Field 346 is for the state of residence. Field 346 may include Canadian providences and Mexican states.

Fields 354 to 366 relate to questions concerning the country of origin of the person being questioned. Field 354 is for city of birth, Field 356 is for the state/province of birth, and Field 358 is for the country of birth. Field 360 is for the country in which the person being quested is currently a citizen. Additionally, Field 360 can be populated with multiple countries, if the person being question has dual citizenship. Field 362 is for the passport number, Field 364 is for the country that issued the passport, and Field 366 is for the status of the passport such as valid or expired.

Fields 368 to 372 are related to illegal entry of the person being questioned into the country. Field 368 is for the date, place, time and manner of last entry or attempted entry. Field 370 is for the status of the entry, such as successful or failed. Field 372 is for the length of time the questioned person has been illegally in the country.

Fields 374 to 381 relate generally to a current or previous foreign residence. Field 374 is for the street name, Field 376 is for the city, Field 378 is for the state/province, and Field 380 is for the country of current or previous foreign residence. Field 381 is for the country from which the questioned person previously arrived.

Fields 382 to 388 relate generally to the questions concerning the current state and vehicle of the questioned person. Field 382 is for the monies in possession which could be in either foreign currency or an estimate of equivalent U.S. dollars. Field 383 is for the vehicle license plate number, Field 384 is for the make of the vehicle, Field 385 is for the model of the vehicle, and Field 386 is for the year of the vehicle. Fields 387 and 388 is for the name of the person who apprehended the questioned person and the date and hour of the apprehension, respectively.

Fields 389 to 392 relate generally to information of the questioned person's visa and social security card. Field 389 is for the visa number and Field 390 is for the date the visa was issued and the country of issuance. Fields 391 and 392 are for the name of the social security card and the social security number, respectively.

Fields 393 to 397 relate generally to questioned person's relatives. Field 393 is for the name of the spouse including maiden name, if appropriate. Fields 394, 395 and 396 relate to the address of the spouse, nationality of the spouse, and number and nationality of the minor children, respectively. Fields 397 are for the father's and mother's names, nationality and addresses, if currently known by the questioned person.

Fields 351 to 355 relate generally to the criminal record, immigration, and F.B.I number, respectively. Field 351 allows for entry of whether or not the questioned person has a criminal record. If the questioned person has a criminal record, the agent may enter the nature of the criminal activity in the notes area. Field 353 allows for entry of whether or not the questioned person has an immigration record. If the questioned person has an immigration record, the agent may enter the nature of the immigration activity in the notes area. Field 355 allows for entry of an F.B.I. number, if appropriate.

FIG. 4A illustrates another exemplary Field Interrogation Card 400 which may be used in a border patrol setting. FIC 400 includes several categories for gathering information about person of interest: situation, subject, associates, and vehicles. In the first category, an agent can collect information about the situation in which the person of interest was interviewed and enter the information into various Fields 401-408. Field 401 concerns the activity the person of interest was engaged in such as driver, passenger, guide, informant, suspect, and other. Field 402 concerns the involvement of the person of interest such as narcotics, aliens, weapons, currency, stash house operations, and other. Field 403 concerns the date on which the person of interest was interviewed. Field 404 concerns the station such as border patrol station at which or near to the person of interest was interviewed. Field 406 concerns the location of the activity such as the map description. Fields 407 and 408 concern the coordinates of the activity, latitude and longitude, respectively.

The subject category in FIC 400 allows the agent to enter personal and identity information of the person of interest in Fields 410-422. Field 410 concerns the full name of the person of interest such as title, given name, surname, and middle name. Field 411 concerns any alias the person of interest may use. Fields 412, 413, 414, 415, 416, and 417 concern physical and personal characteristics: sex, height, weight, hair, eye, and date of birth, respectively. Field 418 concerns the full address of the person of interest such as street number and name, city, state, province, country, and zip code. Field 419 concerns the driver's license number or identification number of the person of interest. Field 420 concerns the state of residence of the person of interest Field 421 concerns the social security number of the person of interest.

The associates category of FIC 400 allows the agent to enter information about the associates of the person of interest. Field 423 concerns the name of the associate of the person of interest. Field 424 concerns the date of birth of the associate of the person of interest. Field 425 concerns the relationship of the person of interest to the associate such as wife, brother, sister, friend.

The vehicles category of FIC 400 allows the agent to enter information regarding the vehicle of the person of interest. Fields 426-432 concern the physical characteristics and registration information of the vehicle. Field 426 concerns the year the vehicle was produced. Field 427 concerns the type of vehicle such as car or truck. Field 428 concerns the make of the vehicle, for example, Ford. Field 429 concerns the model of the vehicle, for example, Mustang. Field 430 concerns the color of the vehicle. Field 431 concerns the license plate number of the vehicle. Field 432 concerns the state or country in which the vehicle is registered. Field 433 concerns the vehicle identification number (“VIN”) of the vehicle. Field 434 concerns the name of the registered owner of the vehicle which may be the same as the person of interest or different. Field 434 concerns the address of the registered owner of the vehicle which may be the same as the address of the person of interest or different.

The last category includes narrative and notes Field 436 in which the agent may enter any information not included in any of the other field or further elaboration on the other fields.

FIG. 4B illustrates another exemplary Field Interrogation Card 440 which may be used by fire inspection agents. FIC 440 includes several categories for gathering information about place of interest: inspection information, business information, building information, and other information. In the first category, an agent can collect information about the site being inspected and can enter this data into various Fields 441-454. Field 442 concerns file number. Field 443 concerns the name of the area inspector. Field 444 concerns the station or division of the area inspector. Field 445 concerns the nature of the inspection whether it is a self-inspection. Field 446 concerns the name of the inspector. Field 447 concerns the work shift of the inspector, such as first shift, second shift, or third shift. Field 449 concerns the location of the fire district. Field 450 concerns the start date of the inspection. Field 451 concerns the frequency of the inspection, such as semi-annually or annually. Field 452 concerns the next inspection date for the fire department.

The business information category in FIC 440 allows the agent or inspector to enter business information of the location being inspected in Fields 455-472. Field 455 concerns the name of the business or d/b/a (doing business as). Fields 456 and 457 concern the business phone and fax number, respectively. Field 458 concerns the complex name, if any, that the location is apart. Field 459 concerns an email address of the business. Fields 460-462 concern the name of the business owner, home phone number, and cell phone number, respectively. Fields 463-465 concern the name of the emergency contact for the business, phone number, and cell phone number, respectively. Fields 466-467 concern the name of the inspection contact for the business and phone number, respectively. Fields 468-469 concern the business license information and expiration date of the license, respectively. Field 472 concerns the business type, such as government or private.

The building information category in FIC 440 allows the agent or inspector to enter building-related information of the location being inspected in Fields 473-494. Fields 473-475 concern the information related to the name of the property owner, phone number and address, respectively. Field 476 concerns the FDC (Fire Department Company) location. Field 477 concerns the gate access code. Field 478 concerns the fire alarm code. Field 480 concerns the construction type of the building, such as wood or brick. Field 481 concerns the number of stories in the building. Field 482 concerns the square footage of the building. Fields 483 and 484 concern the square footage of the units making up the building and the number of units in the building, respectively. Field 485 concerns the roof type of the building. Field 486 concerns the number of employees working in the building. Field 487 concerns number and location of the sprinklers. Field 488 concerns information related to five year test of the sprinklers. Field 489 concerns the supervisory alarm system. Field 490 concerns information related to any protection systems in the building. Fields 491-493 concern hydrants in or near the building. Field 491 concerns information related to two year hydrant test. Field 492 concerns buildings lacking a private hydrant. Field 493 concerns information related to a four year hydrant test. Field 494 concerns the water district of the building.

The other information category in FIC 440 allows the agent or inspector to enter other type information of the location being inspected in Field 495. The types of other information include visits, lock boxes, special information, responding unit comments, permit information, and violation history.

Fields 496-498 concern the name of the inspector, employee number, and date of the inspection, respectively.

FIG. 5 illustrates an exemplary system 500 in which various agents utilize device 100 shown in FIG. 1 or 2 and Field Interrogation Card 300 shown in FIG. 3. The use of Field Interrogation Card 300 in the following examples is for convenience and is not intended to limit the invention. Any Card including the Cards illustrated in FIGS. 4A and 4B and described above may be used with or in replacement of Card 300. In system 500, the various agents (law enforcement agents, border patrol agents, custom agents, transportation security agency agents, and harbor patrol) utilize device 100 in the interviewing of entities of interest. These agents may be in various settings such as a port or dock (setting 506), an international border (setting 508), a traffic stop (setting 510), and an airport (setting 512). Devices 100 at the setting 506, 508, 510, and 512 may be connected to each other via a network 502.

Network 502 may be any local area network or wide area network such as the Internet or any other type of structure to interconnect devices 100 and computer 504. Network 502 may comprise at least one or more communication systems. Communication systems include both the hardware (e.g., network cards) and software for device 100 and computer 504 to interact and communicate data. The types of communication systems that device 100 and computer 504 may communicate through include “communication means” as described in U.S. Pat. No. 5,844,824 which has been previously incorporated by reference in its entirety. In particular, the 824 patent discloses in columns 7-9 various “communication means” including cellular telephone, hardwire telephone, radiofrequency, infrared, and fiber optic communication. Additionally a wired connection in the path of network may be used. Also, device 100 and computer 504 may communicate using different communications systems including different channels, protocols, or types of communication networks through network 502. For example, device 100 may transmit information to computer 504 using one communications path and computer 504 may transmit information to device using a different communications path. The types of communications paths which may be used include wired, satellite, cellular, radio frequencies including WiFi (802.11 a, b, g), or any other current or future wired or wireless protocols.

Computer 504 may contain one or more centrally located or distributed computer systems (not illustrated) for processing, storing, and analyzing information from devices 100. The distributed computer system may be located at the same location or distributed geographically in different locations and communication via network 502. The computer 504 may include a conventional personal computer (PC), a desktop and hand-held device, a multiprocessor computer, a mainframe computer, a server, a personal mobile computing device, a mobile phone, a portable or stationary personal computer, or any of these computers working in combination Computer 504 may also be computers similar to those described in U.S. Pat. No. 5,305,244, U.S. Pat. No. 5,844,824 (“824 patent”), U.S. Pat. No. 6,421,232, or a combination of these computers which have been previously incorporated by reference into the present disclosure. The computer system would contain the conventional components of a computer system such as a processor, memory, storage such as magnetic or optical storage, and input/output hardware.

Computer 504 may receive information from device 100 such as FIC 300 and store the information. Computer 504 may also process the data sent by device 100 and send information back to device 100 via network 502. Computer 504 allows an agent using device 100 to transmit information to computer 504 in order to process and store the information about the entity of interest in real time. As the agent collects information or after the collection of information, device 100 may transmit the information to computer 504.

After receiving the information about the entity of interest, computer 504 may store the information locally or perform analysis on the information. The computer performs analysis on the data using any number of law enforcement data analysis programs. The data analysis programs may be stored in the storage device at the computer 504 and executed by the processor of computer 504. For example, if device 100 transmits fingerprint information of the person of interest to computer 504, the computer may run a fingerprint analysis program. The computer would store the fingerprint information in a storage device at the computer. Then, the computer would load the fingerprint program, execute the program, and begin the analysis on the fingerprint information. The fingerprint program would access the stored fingerprint information and determine the characteristic of the fingerprint characteristics. Then, the fingerprint analysis program access a database of known fingerprints to compare the determined characteristics with the database of known fingerprints. The database of known fingerprints may be stored at the computer or at any other remote storage device. If the fingerprint analysis program matches the fingerprint characteristic with a known fingerprint in the database, the identity of the matched fingerprint would be stored at the computer 504 with the information received from device 100. The example above describes an analysis of a fingerprint. Computer 504 may perform a similar analysis on any information transmitted from device 100. For example, personal information of an entity of interest may be compared with a database of outstanding warrants, most wanted list, and terrorist watch lists.

Once computer 504 has analyzed any information the results of the analysis may be transmitted back to device 100 for use by the agent. As described above, computer 504 may transmit information to device 100 along a different communication system than was used for the transmission of information from device 100 to computer 504. The different types of communication systems include satellite, cellular, WiFi, wired, or any other current or future wired or wireless communication method. For example, if the computer 504 was analyzing identity information and fingerprint information computer 504 may transmit the results of a comparison of the identity information with the fingerprint information.

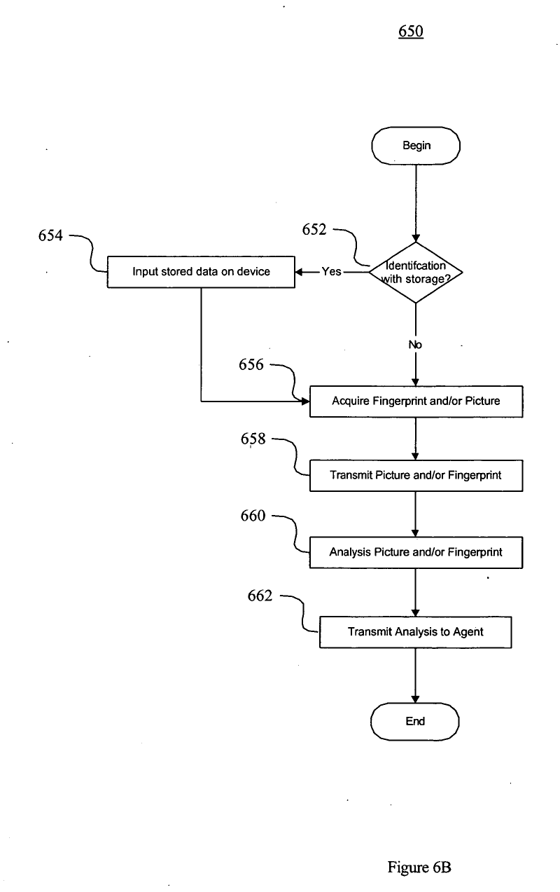

FIG. 6A illustrates an exemplary general procedure 600 that the various agents may use to interview persons of interest at various settings. The procedure described below is given in terms of interviewing a person of interest. This example is merely for convenience and is not intended to limit any aspect of the invention. Any other entity of interest (e.g., vehicle, place, location) may be substituted for the person of interest. First, the agent identifies and approaches a person of interest (stage 602). Then, the agent asks the person of interest if they have any identification (e.g. passport, visa, driver's license) (stage 604). If the person of interest has identification, the agent may begin filing out Field Interrogation Card 300 using the person of interest's identification (stage 606). To fill out Field Interrogation Card 300, the agent inputs information from the identification into device 100 and device 100 populates the fields of Field Interrogation Card 300 (stage 608).

After using the identification or if the person of interest does not have identification, the agent asks the person of interest a series of questions that correspond to fields in Field Interrogation Card 300 (stage 610). If fields have already been addressed at earlier stages, the agent may only ask the questions necessary to fill the remaining fields. As the agent receives the answers from the person of interest, the agent inputs the answers into device 100 and device 100 populates the fields of Field Interrogation Card 300 (stage 612). The agent may not be required to complete all the fields and will complete only those fields that the person of interest can answer or that may be relevant. After all the information has been gathered, the agent may decide to transmit the gathered information to computer 504 via network 502 (stage 614). If the agent chooses not to transmit the data to computer 504, completed Field Interrogation Card 300 may be stored locally on device 100 (stage 616). Optionally, the agent may chose to both store completed Field Interrogation Card 300 and transmit completed Field Interrogation Card 300 to computer 504.

If the agent transmits completed Field Interrogation Card 300, computer 504 may receive and store the completed card on one of its storage devices (stage 618). After storing completed Field Interrogation Card 300, computer 504 may perform analysis on the completed Field Interrogation Card 300 to determine the identify of the person of interest and further information about him (stage 620). This analysis may consist of any standard and conventional analysis performed by law enforcement and government agencies. For example, completed Field Interrogation Card 300 may be compared to database of outstanding warrants, most wanted lists, and terrorist watch list to determine if the person of interest is currently being sought by law enforcement.

After the analysis, computer 504 may transmit any information such as identity and status to device 100 via network 502 (stage 622).

Procedure 600 was described in relation to device 100 without an agent using other information capturing devices such as camera 124, biometric collection unit 126, and card reader 130. The agent may use any of these capturing devices to gather information about a person of interest. FIG. 6B illustrates a procedure 650 in which an agent uses the camera 124, biometric collection unit 126, and card reader 130 to gather information about a person of interest. The stages of procedure 650 may be performed at any stage of procedure 600 illustrated in FIG. 6A. If the stages of procedure 650 are performed, an agent may be able to omit some of the stages of procedure 600 if the relevant information is gathered during procedure 650.

If the person of interest has identification, the agent may determine if the identification is equipped with storage device (e.g. magnetic strip) (stage 652). If so, the agent may input the stored data on the storage device into device 100 using the inputs on device 100 (e.g. card reader 130) and device 100 populates any fields of Card 300 with the inputted data (stage 654).

At this point, if device 100 includes a biometric collection unit 126 or camera 124, the agent may acquire the biometric information (e.g., fingerprint or picture) of the person of interest (stage 656). Once the fingerprint or picture are acquired on device 100, device 100 may store the data or device 100 may transmit the fingerprint or picture to computer 504 via network 502 for storage (stage 658).

After storing the picture or fingerprint, computer 504 may perform analysis on the picture or fingerprint to determine the identity of the person of interest and further information about him (stage 660). This analysis may consist of any standard and conventional analysis performed by law enforcement and government agencies.

For example, if a fingerprint is transmitted to computer 504, the fingerprint may be compared with a database of fingerprints to determine or confirm the identity of the person of interest If a picture is transmitted to computer 504, the picture may be processed by computer 504 using facial recognition software to determine or confirm the identity of the person of interest. If the person of interest's identity is determined, this identity may be compared with a database of outstanding warrants, most wanted lists, and terrorist watch list to determine if the person of interest is currently being sought by law enforcement.

After the analysis, computer 504 may transmit any information such as identity and status to device 100 via network 502 (stage 662).

Now, the exemplary settings illustrated in FIG. 5 will be explained in further detail. In setting 506, a harbor patrol or customs agent may be equipped with device 100. As foreign vessels arrive in port, the agent may use device 100 to gather information on the passengers and crew of the foreign vessel. When the agent approaches the passengers or crew, the agent gathers information to complete Field Interrogation Card 300. The agent may use any procedures illustrated in FIGS. 6A and 6B. For example, as the passengers and crew respond to these questions, the agent inputs the answers into device 100 which populates the fields of card 300.

Likewise, if device 100 includes a biometric collection unit, camera, or card reader, the agent may acquire information about the passengers and crew with these devices. Once information related to the Field Interrogation Card 300 is collected, the agent may communicate the information to computer 504 via network 502 for analysis. Computer 504 may then transmit the results of the analysis back to device 100. Finally, the agent can make a determination of whether to detain the passenger and crew.

By using device 100 in setting 506, the harbor agent is able to identify possible threats before they leave port. Moreover, a record of everyone entering the country is maintained for future reference.

In setting 508, a border patrol agent may be equipped with device 100. As travelers enter a country, the agent may use device 100 to gather information on the travelers. When the agent approaches the travelers, the agent gathers information to complete Field Interrogation Card 300. The agent may use any procedures illustrated in FIGS. 6A and 6B. For example, as the travelers respond to these questions, the agent inputs the answers into device 100 which populates the fields of Card 300.

Likewise, if device 100 includes a biometric collection unit, camera, or card reader, the agent may acquire information about the travelers with these devices. Once information related to the Field Interrogation Card 300 is collected, the agent may communicate the information to computer 504 via network 502 for analysis. Computer 504 may then transmit the results of the analysis back to device 100. Finally, the agent can make a determination of whether to detain the travelers.

By using device 100 in setting 508, the border patrol agent is able to identify possible threats before they can enter a country. Moreover, a record of everyone entering the country is maintained for future reference.

In setting 510, a state and local police officers may be equipped with device 100. During traffic stops or criminal incident, the officer may use device 100 to gather information on the suspects. When the officer approaches the suspects, the officer gathers information to complete Field Interrogation Card 300. The officer may use any procedures illustrated in FIGS. 6A and 6B. For example, as the suspects respond to these questions, the officer inputs the answers into device 100 which populates the fields of Card 300.

Likewise, if device 100 includes a biometric collection unit, camera, or card reader, the officer may acquire information about the suspects with these devices. Once information related to the Field Interrogation Card 300 is collected, the officer may communicate the information to computer 504 via network 502 for analysis. Computer 504 may then transmit the results of the analysis back to device 100. Finally, the officer can make a determination of whether to detain the suspects.

By using device 100 in setting 510, the state and local police officers are able to identify possible threats in real time during a traffic stop or incident.

In setting 512, a transportation security or airline security agent may be equipped with device 100. As travelers arrive in the airport on domestic or foreign flights, the agent may use device 100 to gather information on the travelers. When the agent approaches the travelers, the agent gathers information to complete Field Interrogation Card 300. The agent may use any procedures illustrated in FIGS. 6A and 6B. For example, as the travelers respond to these questions, the agent inputs the answers into device 100 which populates the fields of Card 300.

Likewise, if device 100 includes a biometric collection unit, camera, or card reader, the agent may acquire information about the travelers with these devices. Once information related to the Field Interrogation Card 300 is collected, the agent may communicate the information to computer 504 via network 502 for analysis. Computer 504 may then transmit the results of the analysis back to device 100. Finally, the agent can make a determination of whether to detain the travelers.

By using device 100 in setting 512, the agent is able to identify possible threats before they can enter a country or board a flight. Moreover, a record of everyone entering the country is maintained for future reference.

The present embodiments of this invention are thus to be considered in all respects as illustrative and not restrictive; the scope of the invention being indicated by the appended claims rather than by the foregoing description. All changes that come within the meaning and range of equivalency of the claims are intended to be embraced therein.

What is claimed is:

1. A method for identifying a entity, comprising, under control of a first computer:
inputting data identifying the entity into the first computer, and
transmitting matched information, wherein the matched information comprises a portion of the data matched with a corresponding information field identifier;
under control of a second computer:
receiving the matched information from the first computer;
analyzing the matched information; and
generating a profile of the entity based on the analysis;
wherein the profile is available to the first computer to identify the entity.

2. The method according to claim 1, wherein inputting data comprises capturing at least one of biometric or non-biometric data.

3. The method according to claim 2, wherein the biometric data includes at least one of fingerprint data, handprint data, facial data, or iris information.

4. The method according to claim 2, wherein the non-biometric data includes at least one of identity information, residency information, property information, or relation information.

5. The method according to clam 1, wherein the first computer is a client computer and the second computer is a server computer.

6. The method according to claim 1, wherein analyzing the matched information comprises:
comparing the matched information against a database of entities to determine the identity of the entity, and
searching the database of entities to determine a history of the entity.

7. The method according to claim 1, further comprising storing a portion of the data identifying the entity in a storage device connected to the first computer.

8. The method according to claim 1, further comprising storing at least a portion of the matched information and profile in a storage device connected to the second computer.

9. The method according to claim 1, wherein transmitting matched information further comprises transmitting the matched information through a first communication system and wherein the profile is available to the first computer through a second communication system.

10. A system for identifying an entity, comprising,
a first computer comprising:
a means for inputting data identifying the entity into the first computer,
a means for storing at least a portion of the data identifying the entity, and
a means for transmitting matched information, wherein the matched information comprises the data and a corresponding information field identifier;
a second computer comprising:
a means for analyzing the matched information and generating a profile based on the analysis,
a means for storing the matched information and the profile, and
a means for communicating with the first computer to receive the matched information from the first computer and to transmit the profile to the first computer.

11. The system according to claim 10, wherein the means for communicating with the first computer comprises a first means for receiving the matched information from the first computer and a second means for transmitting the profile from the second computer to the first computer.

12. The system according to claim 10, wherein the means for inputting data comprises at least one of means for capturing biometric information.

13. The system according to claim 10, wherein the means for inputting data comprises at least one of means for capturing non-biometric information.

14. The system according to clam 10, wherein the first computer is a client computer and the second computer is a server computer.

15. A method for interviewing an entity comprising:
identifying information about the entity;
inputting the information about the entity into a portable device;
arranging the information inputted into the portable device in a organized manner to form organized information;
transferring the organized information to a computer;
analyzing the organized information at the computer to generate a profile of the entity;
transferring the profile from the computer to the portable device.

16. The method according to claim 15,
wherein inputting the information about the entity by the portable device comprises capturing personal information about the entity.

17. The method according to claim 16, wherein inputting the information comprises capturing the information from a storage medium.

18. The method according to claim 16, wherein inputting the information comprises capturing a fingerprint of a person.

19. The method according to claim 16, wherein capturing the information comprises capturing a likeness of the entity.

20. The method according to claim 15, wherein analyzing the organized information at the computer comprises comparing the organized information against reference information stored in a storage medium connected to the computer.

21. The method according to claim 16, wherein arranging the information inputted into the portable device in an organized manner to form organized information comprises relating the information to predetermined categories.

22. A method of identification of at least one entity, comprising:
collecting data at a point of inspection related to the at least one entity;
entering the data into a first computer;
transmitting the data to a second computer, wherein the second computer includes storage device, the storage device containing a database of information relating to a plurality of entities;
comparing the data with the database of information stored in the storage device;
generating an individual profile based at least on part of the comparison of the data;
transmitting the profile from the second computer to the first computer.

23. The method of claim 22, wherein the data includes biometric and non-biometric information.

24. The method of claim 22 wherein the first computer comprises at least one of a camera, a fingerprint scanner, a smart card reader, or a GPS receiver.

25. The method of claim 22 wherein the database of information stored in the second computer includes at least one of the following: maiden name, an alias, a nationality, a criminal record, an arrest, a name of a spouse, a name of a relative, a social security number, an information for a visa, an information from a passport, a last time of entry, a last time of being questioned, a country of citizenship, a country of birth, a residence, a driver's license number, and an employer.

26. A system for identifying an entity, comprising,
a first computer comprising:
a first communication bus,
a first processor coupled to the first communication bus,
an input device coupled to the first communication bus for inputting information about the entity into the first computer,
a first storage device coupled to the first communication bus for storing at least a portion of the information and a program to categorize the information and
a first communication device coupled to the first communication bus and in communication with a network;
a second computer comprising:
a second communication bus,
a second processor coupled to the second communication bus,
a second storage device coupled to the second communication bus for storing a program to perform an analysis on the information input into the first computer and generate a profile, and
a second communication device coupled to the second communication bus and in communications with the network,
wherein the profile is available to the first computer via the network.

27. The system of claim 26 further comprising a biometric collection device coupled to the first communication bus.

28. The system of claim 27, wherein the biometric collection device comprises at least one of fingerprint reader or camera.

29. The system of claim 26, wherein the first computer further comprising at least one of GPS receiver or a smart card reader coupled to the first communication bus.
